(19) United States
(12) Patent Application Publication
(10) Pub. No.: US 2003/0126300 A1
(43) Pub. Date: Jul. 3, 2003

(54) Method, system, and product for marking particular types of communications

(75) Inventors: Clifford A. Pickover, Yorktown Heights, NY (US); William Grey, Millwood, NY (US); Paul Andrew Moskowitz, Yorktown Heights, NY (US); Stephen J. Boies, Mahopac, NY (US)

Correspondence Address: Duke W. Yee, Carstens, Yee & Cahoon, LLP, P.O. Box 802334, Dallas, TX, 75380, US

(73) Assignee: International Business Machines Corporation, Armonk, NY (US)

(21) Appl. No.: 10/036,054

(22) Filed: Dec. 31, 2001

(51) Int. Cl. G06F 15/163; G06F 9/54; G06F 9/00

(52) U.S. Cl. 709/310

(57) ABSTRACT

A data processing system, method, and product are disclosed for marking particular types of communications. A database is established that includes multiple different distinguishing identifiers. Each identifier identifies a particular type of communication. A communication is received. A determination is made as to whether the communication includes one of the distinguishing identifiers. Communications that include one of the identifiers are marked.

### BACKGROUND OF THE INVENTION

1. Technical Field

The present invention relates generally to an improved data processing system, and more particularly to a method, system, and product for marking particular types of communications. Still further, the present invention relates to a data processing system, method, and product for marking a communication that may be unwanted before forwarding the communication to its intended recipient.

2. Description of Related Art

The Internet, also referred to as an “internetwork”, is a set of computer networks, possibly dissimilar, joined together by means of gateways that handle data transfer and the conversion of messages from the sending network to the protocols used by the receiving network (with packets if necessary). When capitalized, the term “Internet” refers to the collection of networks and gateways that use the TCP/IP suite of protocols. The Internet has become a cultural fixture as a source of both information and entertainment. Many businesses are creating Internet sites as an integral part of their marketing efforts, informing consumers of the products or services offered by the business or providing other information seeking to engender brand loyalty. Many federal, state, and local government agencies are also employing Internet sites for informational purposes, particularly agencies, such as the Internal Revenue Service and secretaries of state, which must interact with virtually all segments of society. Providing informational guides and/or searchable databases of online public records may reduce operating costs.

With the advent of the Internet, the number of electronic communications has increased sharply. It is very easy using the Internet to communicate with another user via e-mail. This ease-of-use has led to a situation where users are now bombarded with unwanted communications, such as unsolicited e-mails. These unsolicited e-mails are often referred to as “SPAM”.

Therefore, it would be advantageous to have a method, system, and product for marking a particular type of communication before forwarding the communication to its intended recipient.

### SUMMARY OF THE INVENTION

A data processing system, method, and product are disclosed for marking particular types of communications. A database is established that includes multiple different distinguishing identifiers. Each identifier identifies a particular type of communication. A communication is received. A determination is made as to whether the communication includes one of the distinguishing identifiers. Communications that include one of the identifiers are marked.

The above as well as additional objectives, features, and advantages of the present invention will become apparent in the following detailed written description.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a pictorial representation of a distributed data processing system in which the present invention may be implemented;

FIG. 2 is a block diagram of a data processing system that may be implemented as a server in accordance with the present invention;

FIG. 3 is a block diagram of a data processing system that may be implemented as a client in accordance with the present invention;

FIG. 4 depicts a high level flow chart that illustrates storing distinguishing identifiers in a database in accordance with the present invention;

FIG. 5 illustrates a high level flow chart that depicts marking particular types of communications in accordance with the present invention; and

FIG. 6 depicts a high level flow chart that illustrates a recipient receiving marked communications in accordance with the present invention.

### DETAILED DESCRIPTION OF THE PREFERRED EMBODIMENT

The invention is preferably realized using a well-known computing platform, such as an IBM RS/6000 workstation running the IBM AIX operating system. However, it may be realized in other popular computer system platforms, such as an IBM personal computer running the Microsoft Windows operating system or a Sun Microsystems workstation running operating systems such as UNIX or LINUX, without departing from the spirit and scope of the invention.

The present invention is a data processing system, method, and product for marking particular types of communications. For example, unwanted communications or personal communications may be marked. Marking may be accomplished in many fashions, for example: adding text to the subject line (e.g. “SPAM”); sending a message or note to an e-mail application identifying a particular communication as possibly unwanted; embedding the suspected unwanted communication in another note, perhaps with a new subject line; changing attributes of the communication text content or subject line (e.g. Using a different font, using a bold or italicized font, using a larger font, using a blink rate); changing the color of the subject line (e.g. Potential unwanted communications could be displayed in red); changing non-textual attributes of the communications (e.g. Changing the pitch, timbre, play rate (speed), or volume of an audio message, or changing the colors, contrast, play rate (speed), or intensity of a visual communication); adding an icon or symbol next to the suspected unwanted communication (e.g. An image of a ‘thumbs down’, or a percent symbol is placed next to the listing for the communication in an e-mail inbox); positional marking (e.g. Communication are sorted so that unwanted communications are at the bottom or top of a list such as an e-mail inbox list. The communications could appear in an order indicating their predicted relative degree of ‘unwantedness’.); marking for investigation (e.g. Forwarding to a third-party or regulatory agency for enforcement of rules governing unwanted communications, or forwarding to a third party for more detailed analysis.); indirect marking (e.g. Issuing a report listing suspected unwanted communications).

This approach can be applied to both sending and receiving a broad range of communications, including e-mail, instant messaging, XML messages (Extensible Markup Language), EDI messages (Electronic Data Interchange), facsimiles, telephone communications, commercial messages, postal mail, packaging material, broadcasts, digital images, etc.

Some types of communications include distinguishing identifiers which may be used as a signature for that type of communication. For example, unwanted communications often include particular words, such as “sale” or “free”, particular symbols, such as “$”, repeating symbols, such as the repeating “E” in “PLEEEEEASE”, particular colors or fonts, or particular phrases such as “limited time offer”. Each one of these words, symbols, or phrases may be stored in a database as a distinguishing identifier.

Particular senders may often send particular types of communications. Some senders may tend to transmit unwanted communications, while friends and relatives transmit personal communications. The identity of the sender could be used as a distinguishing identifier for purposes of marking communications.

A database of these distinguishing identifiers is established. When a communication is received, a determination is made as to whether the communication includes one of these distinguishing identifiers. Communications that include one of the identifiers are marked and then forwarded to their intended recipients.

FIG. 1 depicts a pictorial representation of a distributed data processing system in which the present invention may be implemented. Distributed data processing system 100 is a network of computers in which the present invention may be implemented. Distributed data processing system 100 contains a network 102, which is the medium used to provide communications links between various devices and computers connected together within distributed data processing system 100. Network 102 may include permanent connections, such as wire or fiber optic cables, or temporary connections made through telephone connections. The communications network 102 also can include other public and/or private wide area networks, local area networks, wireless networks, data communication networks or connections, intranets, routers, satellite links, microwave links, cellular or telephone networks, radio links, fiber optic transmission lines, ISDN lines, T1 lines, DSL, etc. In some embodiments, a user device may be connected directly to a server 104 without departing from the scope of the present invention. Moreover, as used herein, communications include those enabled by wired or wireless technology.

In the depicted example, a server 104 is connected to network 102 along with storage unit 106. In addition, clients 108, 110, and 112 also are connected to network 102. These clients 108, 110, and 112 maybe, for example, personal computers, portable computers, mobile or fixed user stations, workstations, network terminals or servers, cellular telephones, kiosks, dumb terminals, personal digital assistants, two-way pagers, smart phones, information appliances, or network computers. For purposes of this application, a network computer is any computer, coupled to a network, which receives a program or other application from another computer coupled to the network. In the depicted example, server 104 provides data, such as boot files, operating system images, and applications to clients 108-112. Clients 108, 110, and 112 are clients to server 104.

Distributed data processing system 100 may include additional servers, clients, and other devices not shown. In the depicted example, distributed data processing system 100 is the Internet with network 102 representing a worldwide collection of networks and gateways that use the TCP/IP suite of protocols to communicate with one another. At the heart of the Internet is a backbone of high-speed data communication lines between major nodes or host computers, consisting of thousands of commercial, government, educational and other computer systems that route data and messages. Of course, distributed data processing system 100 also may be implemented as a number of different types of networks, such as for example, an intranet, a local area network (LAN), or a wide area network (WAN). FIG. 1 is intended as an example, and not as an architectural limitation for the present invention.

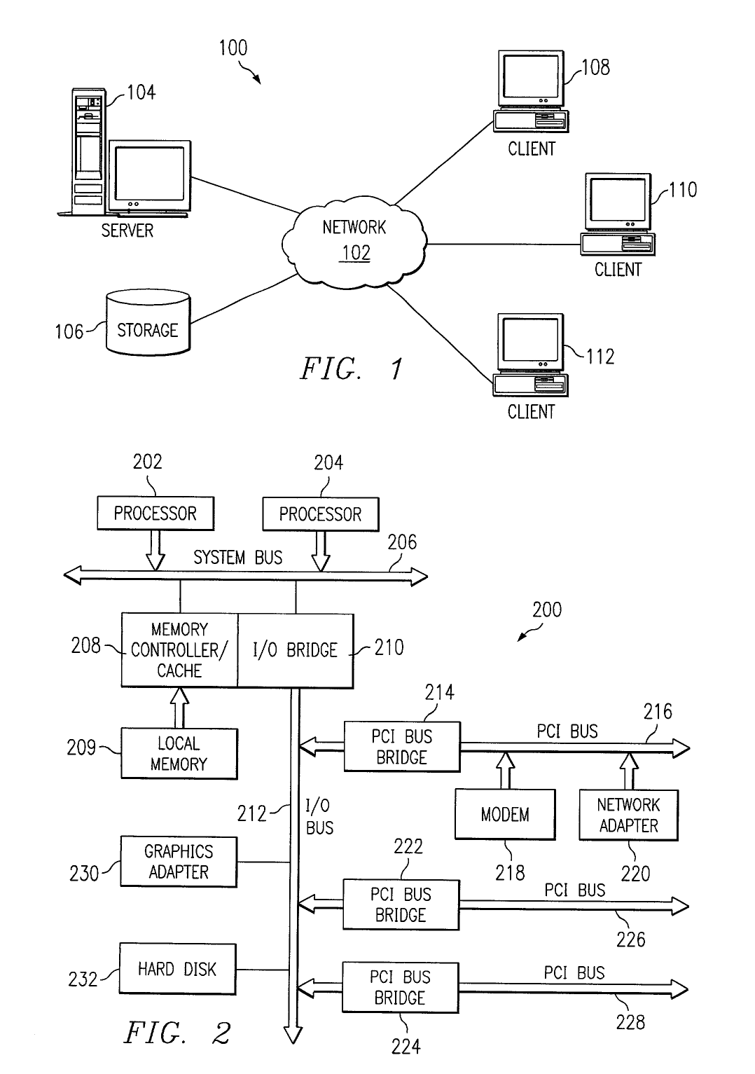

FIG. 2 is a block diagram of a data processing system that may be implemented as a server in accordance with the present invention. Server 200 may be a symmetric multiprocessor (SMP) system including a plurality of processors 202 and 204 connected to system bus 206. Alternatively, a single processor system may be employed. Also connected to system bus 206 is memory controller/cache 208, which provides an interface to local memory 209. I/O bus bridge 210 is connected to system bus 206 and provides an interface to I/O bus 212. Memory controller/cache 208 and I/O bus bridge 210 may be integrated as depicted.

Peripheral component interconnect (PCI) bus bridge 214 connected to I/O bus 212 provides an interface to PCI local bus 216. A number of modems may be connected to PCI local bus 216. Typical PCI bus implementations will support four PCI expansion slots or add-in connectors. Communications links to clients 108-112 in FIG. 1 maybe provided through modem 218 and network adapter 220 connected to PCI local bus 216 through add-in boards.

Additional PCI bus bridges 222 and 224 provide interfaces for additional PCI local buses 226 and 228, from which additional modems or network adapters may be supported. In this manner, server 200 allows connections to multiple network computers. A graphics adapter 230 and hard disk 232 may also be connected to I/O bus 212 as depicted, either directly or indirectly.

Those of ordinary skill in the art will appreciate that the hardware depicted in FIG. 2 may vary. For example, other peripheral devices, such as optical disk drives and the like, also may be used in addition to or in place of the hardware depicted. The depicted example is not meant to imply architectural limitations with respect to the present invention.

The data processing system depicted in FIG. 2 may be, for example, an IBM e-Server pSeries system, a product of International Business Machines Corporation in Armonk, N.Y., running the Advanced Interactive Executive (AIX) operating system or LINUX operating system.

FIG. 3 is a block diagram illustrating a data processing system that may be implemented as a client in accordance with the present invention. Data processing system 300 employs a peripheral component interconnect (PCI) local bus architecture. Although the depicted example employs a PCI bus, other bus architectures such as Accelerated Graphics Port (AGP) and Industry Standard Architecture (ISA) may be used. Processor 302 and main memory 304 are connected to PCI local bus 306 through PCI bridge 308. PCI bridge 308 also may include an integrated memory controller and cache memory for processor 302. Additional connections to PCI local bus 306 may be made through direct component interconnection or through add-in boards.

In the depicted example, local area network (LAN) adapter 310, SCSI host bus adapter 312, and expansion bus interface 314 are connected to PCI local bus 306 by direct component connection. In contrast, audio adapter 316, graphics adapter 318, and audio/video adapter 319 are connected to PCI local bus 306 by add-in boards inserted into expansion slots. Expansion bus interface 314 provides a connection for a keyboard and mouse adapter 320, modem 322, and additional memory 324. Small computer system interface (SCSI) host bus adapter 312 provides a connection for hard disk drive 326, tape drive 328, and CD-ROM drive 330. Typical PCI local bus implementations will support three or four PCI expansion slots or add-in connectors.

An operating system runs on processor 302 and is used to coordinate and provide control of various components within data processing system 300 in FIG. 3. The operating system may be a commercially available operating system, such as Windows 2000, which is available from Microsoft Corporation. An object oriented programming system such as Java may run in conjunction with the operating system and provides calls to the operating system from Java programs or applications executing on data processing system 300. “Java” is a trademark of Sun Microsystems, Inc. Instructions for the operating system, the object-oriented operating system, and applications or programs are located on storage devices, such as hard disk drive 326, and may be loaded into main memory 304 for execution by processor 302.

Those of ordinary skill in the art will appreciate that the hardware in FIG. 3 may vary depending on the implementation. Other internal hardware or peripheral devices, such as flash ROM (or equivalent nonvolatile memory) or optical disk drives and the like, may be used in addition to or in place of the hardware depicted in FIG. 3. Also, the processes of the present invention may be applied to a multiprocessor data processing system.

Data processing system 300 may take various forms, such as a stand-alone computer or a networked computer. As a further example, data processing system 300 may be a personal digital assistant (PDA) device, which is configured with ROM and/or flash ROM in order to provide nonvolatile memory for storing operating system files and/or user-generated data. The depicted example in FIG. 3 and above-described examples are not meant to imply architectural limitations. For example, data processing system 300 also may be a notebook computer or hand held computer in addition to taking the form of a PDA. Data processing system 300 also may be a kiosk or a Web appliance.

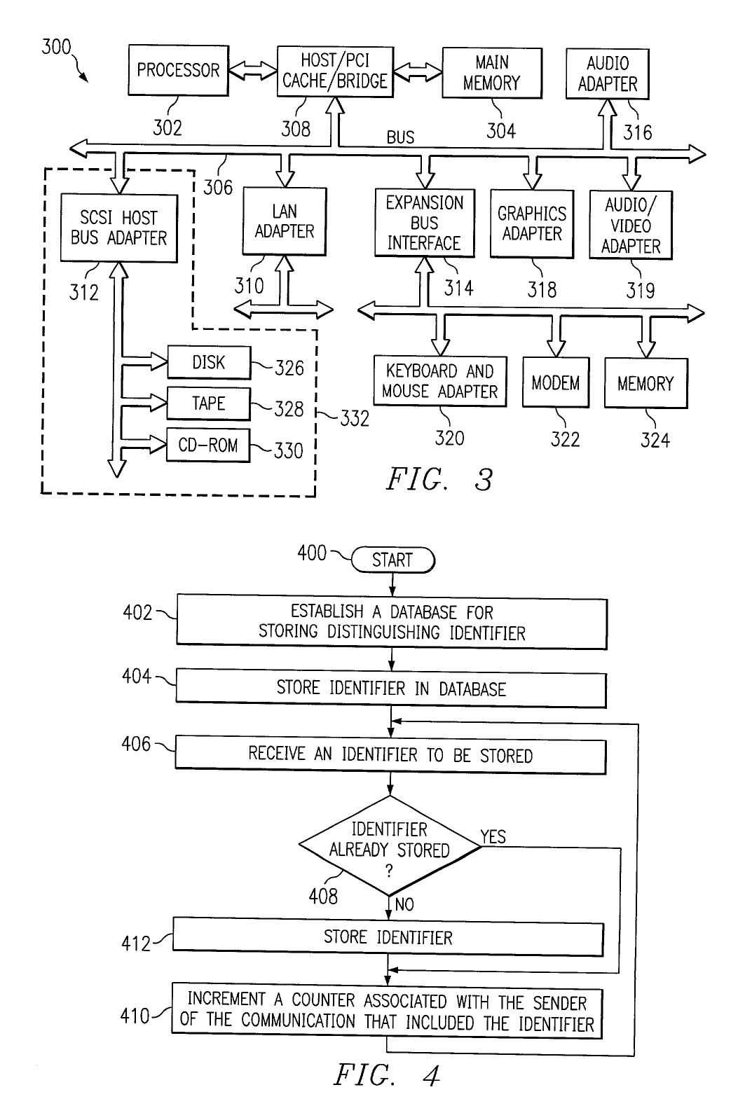

FIG. 4 illustrates a high level flow chart which depicts storing distinguishing identifiers in a database in accordance with the present invention. The process starts as depicted by block 400 and thereafter passes to block 402 which illustrates establishing a database for storing distinguishing identifiers. The identifiers are used to identify particular types of communications. These types of communications include unwanted communications, personal communications, or any other type of communication. A communication will be considered to be a particular type of communication if it includes an identifier that is stored in the database of identifiers. For example, the database may include identifiers that identify unwanted communications. If a received communication includes an identifier that is stored in the database, the communication will be marked as unwanted.

An identifier may be any type of textual string, alphanumeric string, particular string of words, a particular sender, a particular number of intended recipients, a particular return address, a particular language, a particular Internet service provider source, a particular font color, a particular phrase, or any other identifier. The textual string may include repeating letters or symbols. For example, an unwanted communication may include multiple exclamation points, or repeating dollar signs. Other unwanted communications may include the phrase “click here to remove from mailing list”. An identifier may also be graphical or audio. For example, an unwanted communication may contain a graphic or spoken words related to a competitor's computer or related to adult material. Methods for storing and comparing textual, graphical, and audio data are known to those skilled in the art.

Next, block 404 depicts storing identifiers in the database. The process then passes to block 406 which illustrates receiving an identifier to be stored in the database. Next, block 408 depicts a determination of whether or not the identifier is already stored in the database. If a determination is made that the identifier is already stored in the database, the process passes to block 410 which illustrates incrementing a counter that is associated with the sender of the communication that included this identifier. A counter can be established for each sender of a communication that includes either an identifier already included in the database or an identifier determined from a communication that was deleted without opening. The counters can be used to identify a sender who often sends unwanted communications. The process then passes back to block 406. Referring again to block 408, if a determination is made that the identifier has not already been stored in the database, the process passes to block 412 which depicts storing the identifier. The process then passes to block 410.

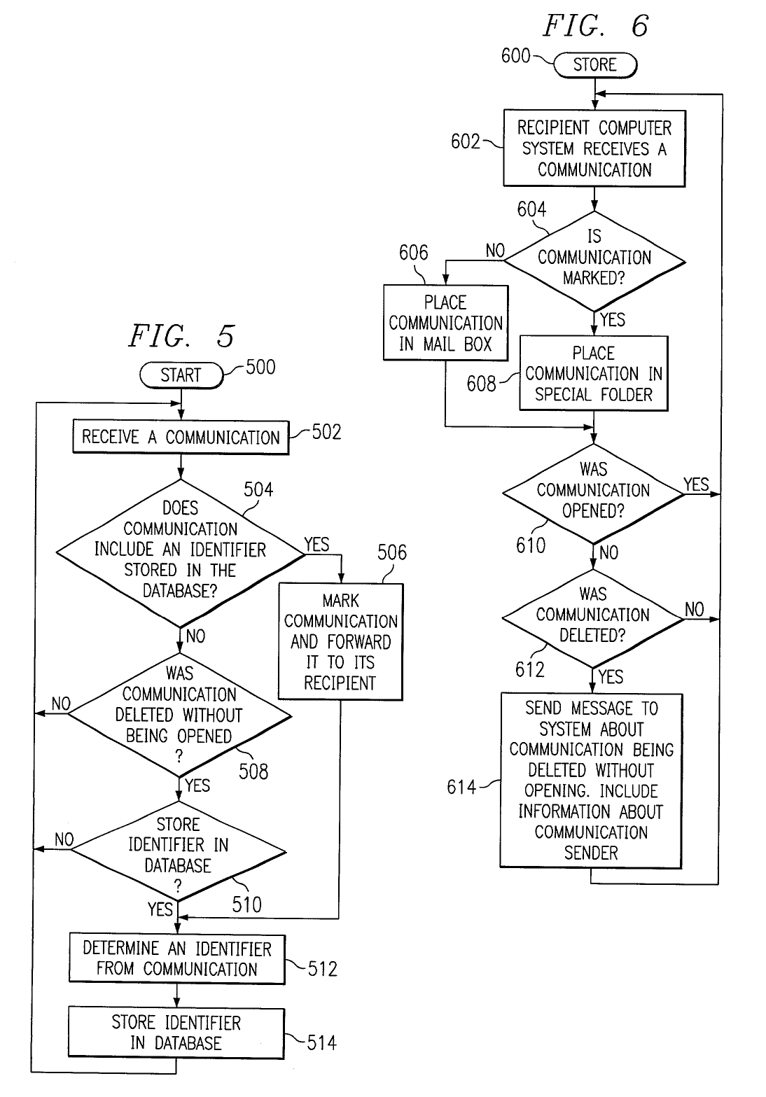

FIG. 5 depicts a high level flow chart which illustrates marking particular types of communications in accordance with the present invention. The process described by FIG. 5 may be executed by a server computer system, a service bureau executing within a server computer system, a Web browser included within a recipient's computer system, or another routine being executed by a recipient's computer system. The present invention may be implemented as a service whereby customers register with the service. Registered customers then have their communications marked as described herein.

The process starts as depicted by block 500 and thereafter passes to block 502 which illustrates a computer system receiving a communication. The communication may be any type of communication such as electronic mail, instant messages, telephone calls, or any other type of communication.

Next, block 504 depicts a determination of whether or not the communication includes one of the identifies stored in the database. If a determination is made that the communication does include one of the identifiers, the process passes to block 506 which illustrates marking the communication and then forwarding it to its intended recipient. Any method may be used for marking a communication. If the process of FIG. 5 is being executed within the recipient's computer system, the communication is forwarded from the Web browser or routine to a service within the recipient's computer system that is used to receive communications. For example, the communication could be forwarded within the recipient's computer system from a Web browser to an e-mail routine. The process then passes to block 514.

Alternatively, the communication could be deleted without forwarding it to the intended recipient.

Referring again to block 504, if a determination is made that the communication does not include one of the identifiers stored in the database, the process passes to block 508 which depicts a determination of whether or not the communication was deleted without being opened. If a determination is made that the communication was not deleted before it was opened, the process passes back to block 502. Referring again to block 508, if a determination is made that the communication was deleted before it was opened, the process passes to block 510 which depicts a determination of whether or not an identifier should be retrieved from the communication and then stored in the database. If a determination is made that an identifier should not be retrieved from the communication and then stored in the database, the process passes back to block 502.

Referring again to block 510, if a determination is made that an identifier should be retrieved from the communication and then stored in the database, the process passes to block 512 which illustrates determining an identifier from the communication. Thereafter, block 514 depicts storing the identifier in the database. The process then passes back to block 502.

The process described above could be modified to block all communications from particular senders. Thus, when a communication is received, if it is from a particular sender, the communication would be discarded before determining if it included an identifier.

FIG. 6 depicts a high level flow chart that illustrates a recipient receiving marked communications in accordance with the present invention. The process starts as depicted by block 600 and thereafter passes to block 602 which illustrates a recipient computer system receiving a communication. This communication may be received from a server computer system, from a Web browser that is executing within the recipient's computer system, or from another service executing within the client computer system.

Next, block 604 depicts a determination of whether or not the communication has been marked. If a determination is made that the communication has not been marked, the process passes to block 606 which illustrates placing the communication in the recipient's mail box. The process then passes to block 610. Referring again to block 604, if a determination is made that the communication has been marked, the process passes to block 608 which depicts placing the communication in a special folder created to hold marked communications.

Next, block 610 illustrates a determination of whether or not the communication has been opened. If a determination is made that the communication has been opened, the process passes back to block 602. Referring again to block 610, if a determination is made that the communication has not been opened, the process passes to block 612 which depicts a determination of whether or not the communication has been deleted. If a determination is made that the communication has not been deleted, the process passes to block 602. Referring again to block 612, if a determination is made that the communication has been deleted, the process passes to block 614 which illustrates sending a message to the server computer system about the communication being deleted without being opened. Information is included about the communication's sender. The process passes to block 602.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method in a data processing system for marking particular types of communications, said method comprising the steps of:
establishing a database of a plurality of different distinguishing identifiers, wherein each of said plurality of identifiers identifies a particular type of communication;
receiving a communication;
determining if said communication includes one of said plurality of different identifiers; and
in response to a determination that said communication does include one of said plurality of different identifiers, marking said communication.

2. The method according to claim 1, further comprising the step of forwarding said marked communication.

3. The method according to claim 1, further comprising the steps of:
receiving a communication within a server computer system intended to be received by a recipient's computer system;
determining within a server computer system if said communication includes one of said plurality of different identifiers;
in response to a determination that said communication does include one of said plurality of different identifiers, marking, utilizing said server computer system, said communication; and
forwarding said marked communication from said server computer system to said recipient's client computer system.

4. The method according to claim 3, further comprising the steps of:
receiving a communication within a service bureau in a server computer system intended to be received by a recipient's computer system;
determining within said service bureau in said server computer system if said communication includes one of said plurality of different identifiers;
in response to a determination that said communication does include one of said plurality of different identifiers, marking, utilizing said service bureau in said server computer system, said communication; and
forwarding said marked communication from said service bureau in said server computer system to said recipient's client computer system.

5. The method according to claim 4, further comprising the step of compensating said service bureau.

6. The method according to claim 1, further comprising the step of establishing said database of said plurality of different distinguishing identifiers, wherein each of said plurality of identifiers identifies an unwanted communication.

7. The method according to claim 1, further comprising the step of deleting marked communications before said marked communications are forwarded to their intended recipients.

8. The method according to claim 1, further comprising the steps of:
in response to a determination that said communication does not include one of said plurality of different identifiers, forwarding said communication;
determining whether said communication was deleted without being opened;
in response to a determination that said communication was deleted without being opened, determining an identifier included within said communication; and
storing said identifier as one of said plurality of identifiers in said database.

9. The method according to claim 1, further comprising the step of publishing said plurality of identifiers included within said database.

10. The method according to claim 1, further comprising the step of subscribing to a service that provides said plurality of identifiers.

11. The method according to claim 1, further comprising the step of forwarding said communication to a special folder designated for receiving communication that are said particular type.

12. The method according to claim 1, further comprising the step of notifying a sender of said marked communication to discontinue communications to an intended recipient of said marked communication.

13. The method according to claim 12, further comprising the step of blocking further communications from said sender.

14. The method according to claim 1, further comprising the step of establishing said database of said plurality of different distinguishing identifiers, each one of said plurality of identifiers identifying a sender.

15. The method according to claim 1, further comprising the step of establishing said database of said plurality of different distinguishing identifiers, one of said plurality of identifiers identifying a total number of times communications have been received from a sender who transmitted said marked communication.

16. The method according to claim 1, further comprising the step of establishing said database of said plurality of different distinguishing identifiers, one of said plurality of identifiers identifying a particular text string.

17. The method according to claim 1, further comprising the stop of establishing said database of said plurality of different distinguishing identifiers, one of said plurality of identifiers identifying a number of intended recipients.

18. The method according to claim 1, further comprising the step of establishing said database of said plurality of different distinguishing identifiers, one of said plurality of identifiers identifying a particular sender.

19. The method according to claim 1, further comprising the step of establishing said database of said plurality of different distinguishing identifiers, one of said plurality of identifiers identifying a particular return address.

20. The method according to claim 1, further comprising the step of establishing said database of said plurality of different distinguishing identifiers, one of said plurality of identifiers identifying a particular language.

21. The method according to claim 1, further comprising the step of establishing said database of said plurality of different distinguishing identifiers, one of said plurality of identifiers identifying a particular Internet service provider source.

22. The method according to claim 1 wherein said communication comprises at least one of e-mail, instant messaging, XML messages, EDI messages, facsimiles, telephone communications, commercial messages, postal mail, packaging material, or digital images.

23. The method according to claim 22, further comprising the step of determining if said communication is an unsolicited communication.

24. The method according to claim 1, wherein said communication comprises adult material.

25. The method according to claim 22, wherein said step of marking said communication further comprises the step of marking said communication utilizing at least one of: adding text to a subject line; sending a message or note to an e-mail application identifying a particular communication as possibly unwanted; embedding the suspected unwanted communication in another note; changing at least one attribute of a portion of the communication text; changing the color of the subject line; changing non-textual attributes of the communication; adding an icon; adding a symbol; positional marking; marking for investigation; forwarding to a third-party; or issuing a report.

26. The method according to claim 1 wherein said step of marking said communication further comprises the step of marking said communication utilizing at least one of: adding text to a subject line; sending a message or note to an e-mail application identifying a particular communication as possibly unwanted; embedding the suspected unwanted communication in another note; changing at least one attribute of a portion of the communication text; changing the color of the subject line; changing non-textual attributes of the communication; adding an icon; adding a symbol; positional marking; marking for investigation; forwarding to a third-party; or issuing a report.

27. A method in a data processing system for marking particular types of communications, said method comprising the steps of:
preparing an unsolicited communication;
marking said communication as being unsolicited; and
sending said communication.

28. A data processing system for marking particular types of communications, said system comprising:
a database of a plurality of different distinguishing identifiers, wherein each of said plurality of identifiers identifies a particular type of communication;
means for receiving a communication;
means for determining if said communication includes one of said plurality of different identifiers; and
in response to a determination that said communication does include one of said plurality of different identifiers, means for marking said communication.

29. The system according to claim 28, further comprising means for forwarding said marked communication.

30. The system according to claim 28, further comprising:
means for receiving a communication within a server computer system intended to be received by a recipient's computer system;
means for determining within a server computer system if said communication includes one of said plurality of different identifiers;
in response to a determination that said communication does include one of said plurality of different identifiers, means for marking, utilizing said server computer system, said communication; and
means for forwarding said marked communication from said server computer system to said recipient's client computer system.

31. The system according to claim 30, further comprising:
means for receiving a communication within a service bureau in a server computer system intended to be received by a recipient's computer system;
means for determining within said service bureau in said server computer system if said communication includes one of said plurality of different identifiers;
in response to a determination that said communication does include one of said plurality of different identifiers, means for marking, utilizing said service bureau in said server computer system, said communication; and
means for forwarding said marked communication from said service bureau in said server computer system to said recipient's client computer system.

32. The system according to claim 31, further comprising means for compensating said service bureau.

33. The system according to claim 28, further comprising of said database of said plurality of different distinguishing identifiers, wherein each of said plurality of identifiers identifies an unwanted communication.

34. The system according to claim 28, further comprising means for deleting marked communications before said marked communications are forwarded to their intended recipients.

35. The system according to claim 28, further comprising:
in response to a determination that said communication does not include one of said plurality of different identifiers, means for forwarding said communication;
means for determining whether said communication was deleted without being opened;
in response to a determination that said communication was deleted without being opened, means for determining an identifier included within said communication; and
means for storing said identifier as one of said plurality of identifiers in said database.

36. The system according to claim 28, further comprising means for publishing said plurality of identifiers included within said database.

37. The system according to claim 28, further comprising means for subscribing to a service that provides said plurality of identifiers.

38. The system according to claim 28, further comprising means for forwarding said communication to a special folder designated for receiving communication that are said particular type.

39. The system according to claim 28, further comprising means for notifying a sender of said marked communication to discontinue communications to an intended recipient of said marked communication.

40. The system according to claim 39, further comprising means for blocking further communications from said sender.

41. The system according to claim 28, further comprising means for establishing said database of said plurality of different distinguishing identifiers, each one of said plurality of identifiers identifying a sender.

42. The system according to claim 28, further comprising means for establishing said database of said plurality of different distinguishing identifiers, one of said plurality of identifiers identifying a total number of times communications have been received from a sender who transmitted said marked communication.

43. The system according to claim 28, further comprising means for establishing said database of said plurality of different distinguishing identifiers, one of said plurality of identifiers identifying a particular text string.

44. The system according to claim 28, further comprising means for establishing said database of said plurality of different distinguishing identifiers, one of said plurality of identifiers identifying a number of intended recipients.

45. The system according to claim 28, further comprising establishing said database of said plurality of different distinguishing identifiers, one of said plurality of identifiers identifying a particular sender.

46. The system according to claim 28, further comprising establishing said database of said plurality of different distinguishing identifiers, one of said plurality of identifiers identifying a particular return address.

47. The system according to claim 28, further comprising establishing said database of said plurality of different distinguishing identifiers, one of said plurality of identifiers identifying a particular language.

48. The system according to claim 28, further comprising establishing said database of said plurality of different distinguishing identifiers, one of said plurality of identifiers identifying a particular Internet service provider source.

49. The system according to claim 28 wherein said communication comprises at least one of e-mail, instant messaging, XML messages, EDI messages, facsimiles, telephone communications, commercial messages, postal mail, packaging material, or digital images.

50. The system according to claim 49, further comprising means for determining if said communication is an unsolicited communication.

51. The system according to claim 28, wherein said communication comprises adult material.

52. The system according to claim 49, wherein said means for marking said communication further comprises means for marking said communication utilizing at least one of: adding text to a subject line; sending a message or note to an e-mail application identifying a particular communication as possibly unwanted; embedding the suspected unwanted communication in another note; changing at least one attribute of a portion of the communication text; changing the color of the subject line; changing non-textual attributes of the communication; adding an icon; adding a symbol; positional marking; marking for investigation; forwarding to a third-party; or issuing a report.

53. The system according to claim 28, wherein said means for marking said communication further comprises means for marking said communication utilizing at least one of: adding text to a subject line; sending a message or note to an e-mail application identifying a particular communication as possibly unwanted; embedding the suspected unwanted communication in another note; changing at least one attribute of a portion of the communication text; changing the color of the subject line; changing non-textual attributes of the communication; adding an icon; adding a symbol; positional marking; marking for investigation; forwarding to a third-party; or issuing a report.

54. A data processing system for marking particular types of communications comprising:
means for preparing an unsolicited communication;
means for marking said communication as being unsolicited; and
means for sending said communication.

55. A computer program product in a data processing system for marking particular types of communications, said computer program product comprising:
instruction means for establishing a database of a plurality of different distinguishing identifiers, wherein each of said plurality of identifiers identifies a particular type of communication;
instruction means for receiving a communication;
instruction means for determining if said communication includes one of said plurality of different identifiers; and
in response to a determination that said communication does include one of said plurality of different identifiers, instruction means for marking said communication.

56. The product according to claim 55, further comprising instruction means for forwarding said marked communication.

57. The product according to claim 55, further comprising:
instruction means for receiving a communication within a server computer system intended to be received by a recipient's computer system;
instruction means for determining within a server computer system if said communication includes one of said plurality of different identifiers;
in response to a determination that said communication does include one of said plurality of different identifiers, instruction means for marking, utilizing said server computer system, said communication; and
instruction means for forwarding said marked communication from said server computer system to said recipient's client computer system.

58. The product according to claim 57, further comprising:
instruction means for receiving a communication within a service bureau in a server computer system intended to be received by a recipient's computer system;
instruction means for determining within said service bureau in said server computer system if said communication includes one of said plurality of different identifiers;
in response to a determination that said communication does include one of said plurality of different identifiers, instruction means for marking, utilizing said service bureau in said server computer system, said communication; and
instruction means for forwarding said marked communication from said service bureau in said server computer system to said recipient's client computer system.

59. The product according to claim 58, further comprising instruction means for compensating said service bureau.

60. The product according to claim 55, further comprising instruction means for establishing said database of said plurality of different distinguishing identifiers, wherein each of said plurality of identifiers identifies an unwanted communication.

61. The product according to claim 55, further comprising instruction means for deleting marked communications before said marked communications are forwarded to their intended recipients.

62. The product according to claim 55, further comprising:
in response to a determination that said communication does not include one of said plurality of different identifiers, instruction means for forwarding said communication;
instruction means for determining whether said communication was deleted without being opened;
in response to a determination that said communication was deleted without being opened, instruction means for determining an identifier included within said communication; and
instruction means for storing said identifier as one of said plurality of identifiers in said database.

63. The product according to claim 55, further comprising instruction means for publishing said plurality of identifiers included within said database.

64. The product according to claim 55, further comprising instruction means for subscribing to a service that provides said plurality of identifiers.

65. The product according to claim 55, further comprising instruction means for forwarding said communication to a special folder designated for receiving communication that are said particular type.

66. The product according to claim 55, further comprising instruction means for notifying a sender of said marked communication to discontinue communications to an intended recipient of said marked communication.

67. The product according to claim 66, further comprising instruction means for blocking further communications from said sender.

68. The product according to claim 55, further comprising instruction means for establishing said database of said plurality of different distinguishing identifiers, each one of said plurality of identifiers identifying a sender.

69. The product according to claim 55, further comprising instruction means for establishing said database of said plurality of different distinguishing identifiers, one of said plurality of identifiers identifying a total number of times communications have been received from a sender who transmitted said marked communication.

70. The product according to claim 55, further comprising instruction means for establishing said database of said plurality of different distinguishing identifiers, one of said plurality of identifiers identifying a particular text string.

71. The product according to claim 55, further comprising instruction means for establishing said database of said plurality of different distinguishing identifiers, one of said plurality of identifiers identifying a number of intended recipients.

72. The product according to claim 55, further comprising instruction means for establishing said database of said plurality of different distinguishing identifiers, one of said plurality of identifiers identifying a particular sender.

73. The product according to claim 55, further comprising instruction means for establishing said database of said plurality of different distinguishing identifiers, one of said plurality of identifiers identifying a particular return address.

74. The product according to claim 55, further comprising instruction means for establishing said database of said plurality of different distinguishing identifiers, one of said plurality of identifiers identifying a particular language.

75. The product according to claim 55, further comprising instruction means for establishing said database of said plurality of different distinguishing identifiers, one of said plurality of identifiers identifying a particular Internet service provider source.

76. The product according to claim 55, wherein said communication comprises at least one of e-mail, instant messaging, XML messages, EDI messages, facsimiles, telephone communications, commercial messages, postal mail, packaging material, or digital images.

77. The product according to claim 76, further comprising instruction means for determining if said communication is an unsolicited communication.

78. The product according to claim 55, wherein said communication comprises adult material.

79. The product according to claim 76, wherein said instruction means for marking said communication further comprises instruction means for marking said communication utilizing at least one of: adding text to a subject line; sending a message or note to an e-mail application identifying a particular communication as possibly unwanted; embedding the suspected unwanted communication in another note; changing at least one attribute of a portion of the communication text; changing the color of the subject line; changing non-textual attributes of the communication; adding an icon; adding a symbol; positional marking; marking for investigation; forwarding to a third-party; or issuing a report.

80. The product according to claim 55, wherein said instruction means for marking said communication further comprises instruction means for marking said communication utilizing at least one of: adding text to a subject line; sending a message or note to an e-mail application identifying a particular communication as possibly unwanted; embedding the suspected unwanted communication in another note; changing at least one attribute of a portion of the communication text; changing the color of the subject line; changing non-textual attributes of the communication; adding an icon; adding a symbol; positional marking; marking for investigation; forwarding to a third-party; or issuing a report.

81. A computer program product in a data processing system for marking particular types of communications, said computer program product comprising:
instruction means for preparing an unsolicited communication;
instruction means for marking said communication as being unsolicited; and
instruction means for sending said communication.
